(19) United States
(12) Patent Application Publication
(10) Pub. No.: US 2008/0295112 A1
(43) Pub. Date: Nov. 27, 2008

(54) Secure Inter-Process Communication Channel

(76) Inventor: Fabrizio Muscarella, Mannheim (DE)

Correspondence Address: SAP/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/752,853

(22) Filed: May 23, 2007

(51) Int. Cl. G06F 9/44

(52) U.S. Cl. 719/313

(57) ABSTRACT

Methods and apparatuses enable secure inter-process communication between processes. The processes may be of different privilege levels. A first process can open a control or bind channel, which enables a second process to establish a connection with the first process. The second process connects to the first process via the control channel, which the first process may then delete. Without the control channel, other processes cannot establish connections with the first process, but the two processes that already established a communication connection can communicate.

### FIELD

Embodiments of the invention relate to inter-process communication, and more particularly to security of an inter-process communication channel.

### BACKGROUND

There are many applications for inter-process communication. Different processes executing on a system or a network can communicate with each other to pass data, configuration information, etc. One common method of inter-process communication is through the use of named pipes. Traditionally, any process with sufficient security checks can access a named pipe. That is, any process that can provide security or authentication information sufficient to access a named pipe can access the communication channel.

Consider a scenario when a process of a particular privilege level is to communicate with a process of a lower privilege level, the privilege level needed to access the pipe is effectively lowered to allow the lower-privilege process to access the pipe. Note that typically any process having a privilege level that enables the process to “see” the pipe can access the pipe. A process may be able to access the pipe even if it is not the process for which the pipe was intended to be opened. That is, a pipe can be hacked or hijacked from a much lower level of security. Thus, lowering the privilege level needed to access a pipe can create a security risk in enabling a lower-privileged process to access a higher-privileged process.

Traditional inter-process communication posed security risks that could enable a high-privilege level process to be compromised from a lower-privilege level process because of the lowering of the privilege level needed to communicate between the processes. Alternatively, communication between processes of different privilege levels could simply be forbidden, which presented usability and interoperability problems.

### SUMMARY

Methods and apparatuses enable secure inter-process communication between processes. The processes may be of different privilege levels. A first process can open a control or bind channel, which enables a second process to establish a connection with the first process. The second process connects to the first process via the control channel, which the first process may then delete. Without the control channel, other processes cannot establish connections with the first process, but the two processes that already established a communication connection can communicate.

In one embodiment, the first process is a privileged process, and the second process is a user process that has little or no privileges. The control channel may be used to exchange protocol information that enables other channels or connections to be established, over which data is exchanged. Deleting the control channel can mean closing the control channel or deleting reference to the control channel from the system. One or more communication connections may still be active, and not closed with the closing of the control channel. However, without a control channel, other processes cannot obtain configuration or protocol information necessary to communicate with the first process over the maintained communication connections.

### BRIEF DESCRIPTION OF THE DRAWING

The following description includes discussion of a figure having illustrations given by way of example of implementations of embodiments of the invention. The drawing should be understood by way of example, and not by way of limitation.

FIG. 1 is a block diagram of an embodiment of a system having a secure inter-process communication channel.

FIG. 2 is a block diagram of an embodiment of processes that share a secure communication channel between them.

FIG. 3 is a block diagram of an embodiment of a root process that communicates with a user process over one or more communication channels generated with a control channel.

FIG. 4 is a flow diagram of an embodiment of a process for establishing a secure inter-process communication channel.

### DETAILED DESCRIPTION

As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive. Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

Secure inter-process communication between processes can be achieved as described herein. One process operates as a control process, and establishes a bind channel or a connection endpoint. In one embodiment, the bind channel is wide open, which enables any requesting process to connect to the control process. Thus, an accessing process accesses the endpoint and establishes one or more communication connections with the control process. As used herein, “control channel” and “bind channel” refer to a communication link over which connections may be established. Protocol and other configuration information may be exchanged via the control channel that enables establishing communication connections. As used herein, a communication connection refers to a communication link that is established between two processes to enable the processes to communicate with each other. Note that the naming conventions used herein are for purposes of simplicity in description, and should not be interpreted as limiting or restricting in any sense. Other terminology could be employed to refer to the communication links described herein. Whereas the control channel may be visible or accessible to any process, the communication connections are established between processes, and are not open for access to other processes. A generic handshake between the processes may be used to certify each connection.

The accessing process may establish one or more connections with the control process. After all connections are created, the control connection is made inaccessible and/or not viewable by other processes within the system. In one embodiment, a transport layer used in the control channel is eliminated or deleted to prevent other processes (or even the accessing process) from establishing further connections. Thus, no more connections are possible via the control channel. Without access to the control channel, other connections cannot be made, and the connections that are made become inaccessible to other processes. Thus, the communication connections (which may also be referred to as input/output (I/O) channels) become secure communication channels over which the control and accessing processes may communicate. Note that although described with reference to a single accessing process, the same principles could be employed to establish connections with multiple accessing processes. Thus, in one embodiment, a control processes establishes a control channel, which is accessed by multiple accessing processes. The accessing processes and the control process establish connections, after which the control channel is deleted. In such a manner, multiple accessing processes could have secure communication channels established with the control process.

In one embodiment, the control process is a privileged process, and the accessing process(es) can be user process(es) with little or no privileges. Deleting the control channel can mean closing the control channel or deleting reference to the control channel from the system. Note that closing or deleting the control channel does not automatically close the communication connections, which can be closed independently of the control channel. Thus, one or more communication connections may still be active after closing the control channel. However, as mentioned above, without a control channel, other processes cannot obtain configuration or protocol information necessary to communicate with the first process over the maintained communication connections.

The control channel or the controlling communication channel employs a protocol based on or compatible with an OS transport layer (e.g., inter-procedure call (IPC), Unix Domain Socket (UDS) on Unix, NamedPipe on Windows). Note that UNIX and WINDOWS are trademarks respectively owned by Sun Microsystems, Inc. of Mountain View, Calif., and Microsoft Corporation of Redmond, Wash. All trademarks used herein are used solely for purposes of identification, as all trademarks are the property of their respective owners. The protocol supports different message types, which enables more specific, rather than only generic, executable operations to be performed by the control process. Thus, the accessing process may request specific operations.

In one embodiment, the communication connections or I/O channels are implemented with non-blocking capability. Additionally, the connections may be implemented with multiplexing. The system can be configured to accommodate any reasonable number of connections, as is understood in the art. An example of a number of connections that may be established is ten. Note that an operating system under which the control process is executing is unable to view the control channel once the control process deletes it. Thus, if another process attempts to access the control channel to configure itself to communicate with the control process over the communication connections, the OS will return an error indicating that the socket for configuring the communication does not exist. In one embodiment, all communication links, both the control channel and the communication connections are implemented as file descriptors. In such an implementation, all communication connections are created by a bind file descriptor. The bind file descriptor can be deleted, which eliminates the channel. In one embodiment, creating a channel means creating a socket. the control process may create a directory accessible to itself (e.g., as an IPC communication object).

In one embodiment, the control process is a higher-privileged process than the accessing process, which may be, for example, root and user processes, respectively. The root user can be bound to a communication control channel and initiate execution of the user process with root privilege. That is, the user process may be initiated as root, and then changed back to user after communication connections are established between the root and user processes.

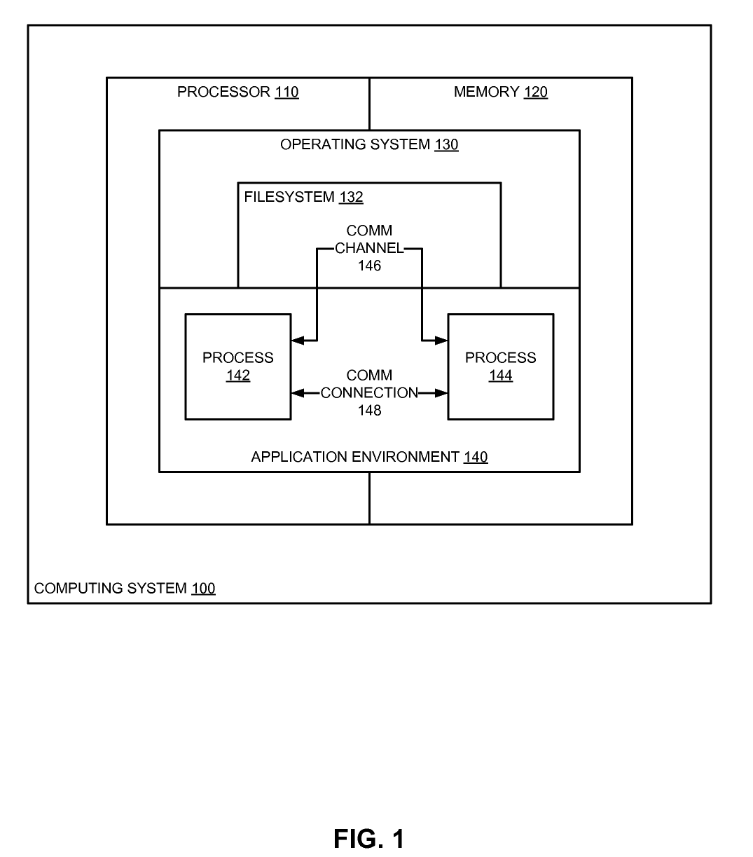

FIG. 1 is a block diagram of an embodiment of a system having a secure inter-process communication channel. Computing system 100 represents any of a number of hardware resources on which inter-process communication may take place. Note that the hardware resources could be some or all of the resources of a physical machine. Not all resources need to be located on the same physical device. Computing system 100 includes one or more processors 110, which control the operation of computing system 100. Processor 110 may include any type of microprocessor, central processing unit (CPU), or programmable general-purpose or special-purpose microprocessors. Computing system 100 includes memory 120, which represents the main memory of computing system 100 to provide temporary storage for code and/or data to be executed by processor 110. Memory 120 may include read-only memory (ROM), flash memory, one or more varieties of random access memory (RAM, e.g., static RAM (SRAM), dynamic RAM (DRAM), synchronous DRAM (SDRAM), etc.), or a combination of memory technologies.

Various other components are shown overlaid on top of processor 110 and memory 120, representing the fact that one or more elements of the displayed components may exist in memory and be executed by processor 110. A process may be stored in non-volatile storage and loaded to memory 120 for execution. Among other possible components, computing system 100 is shown with operating system (OS) 130, which represents a managing program or programs. OS 130 may include various programs that operate together to manage hardware and software resources of computing system 100. OS 130 includes filesystem 132, which represents a file management kernel or core application. Filesystem 132 as used herein refers to components generally responsible for managing where files or data are to be located within storage and/or memory.

Note that computing system 100 includes one or more components not specifically shown, such as a system bus that provides component connectivity, one or more network interface(s) for accessing remote entities, one or more input/output (I/O) interface(s) for human/user interaction, and one or more non-volatile storage devices.

Computing system 100 also includes application environment 140, which may be understood as running “on top of” OS 130, or “under” OS 130, depending upon the desired terminology. When a program runs on top of an OS, it refers to the fact the OS acts as a background or a base system that allows other programs to execute. When referring to running under the OS, it implies the privilege or control relationships of the OS and the other program. Under either of these explanations, or as described by other terminology, the application environment is managed by OS 130, and uses the resources of computing system 100. Application environment 140 includes process 142 and process 144. Processes 142-144 are programs or applications or modules executing on computing system 100. Although both are shown within application environment 142, it will be understood that one of the processes can be remote from computing system 100. A remote process may still be able to access and utilize the resources of computing system 100, and can thus be conceptually shown within application environment 140 of computing system 100.

In one embodiment, process 142 is a control process and process 144 is an accessing process. Process 142 generates communication channel 146, which represents a control channel over which process 144 can establish one or more communication connections 148 between process 144 and control process 142. In one embodiment, communication channel 146 is a socket that is available to the system via filesystem 132. Process 144 can access communication channel 146 via filesystem 132, and then establish communication connection 148 as an I/O channel with process 142. After all communication connections are established, communication channel 146 is eliminated from the system, while communication connection 148 remains.

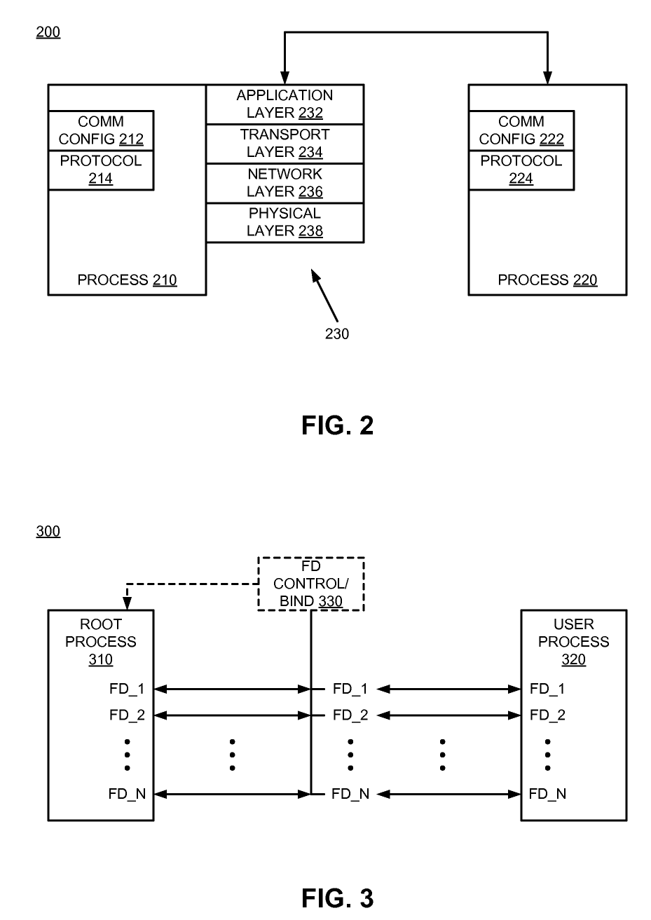

FIG. 2 is a block diagram of an embodiment of processes that share a secure communication channel between them. System 200 includes process 210 that acts as a control process, and process 220 that acts as an accessing process. Note that processes 210 and 220 are not necessary executing on the same physical hardware, but may be coupled via a network connection. In one embodiment, process 210 has one privilege level (e.g., root) and process 220 has a lower privilege level (e.g., user). In order to communicate in a secure manner, process 210 generates a control channel. In one embodiment, process 210 initiates execution of process 220. Process 220 may be initiated as root, and then changed back to user once communication connections are established. For example, process 220 may generate a directory that is accessible to root itself, then initiate process 220 as root to enable process 220 to access the directory. The directory can be utilized as a communication channel, as is understood in the art. Via the directory, one or more file descriptors can be established that allow the processes to communicate. The directory can then be eliminated and the file descriptors remain.

In one embodiment, the communication between process 210 and process 220 can be viewed as operating under a stack model, with physical layer 238, network layer 236, transport layer 234, and application layer 232. Physical layer 238 provides interfacing with hardware resources that transmit, receive, and process signals. Physical layer 238 defines electrical and physical specifications for the communication hardware. Network layer 236 handles routing and transmission quality issues. Transport layer 234 controls the reliability and control of the communication channel. Such functions could be handled by the processes themselves, if a communication link were configured to handle such functions between the processes. Application layer 232 provides the ability for a user to access the communication link. The application layer may also handle higher-level functions such as security, encryption, etc. In one embodiment, a communication connection is established between processes 210 and 220, and the transport layer is eliminated. The establishing of one or more communication connections can establish protocol and configuration for communicating on the connections. However, other processes become unable to access the connections.

Both processes 210 and 220 are shown having communication configuration (comm config) 212 and 222, respectively, and protocol 214 and 224, respectively. Communication configuration 212 and 222 and protocol 214 and 224 illustrate that processes 210 and 220 establish the configuration and protocol to establish the communication connections. Such configuration and protocol enables processes 210 and 220 to continue to communicate on the communication connections after elimination of the transport layer.

FIG. 3 is a block diagram of an embodiment of a root process that communicates with a user process over one or more communication channels generated with a control channel. System 300 represents a system in which processes engage in inter-process communication. Root process 310 represents a process with privilege, and is a control process for purposes of inter-process communication. Root process 310 generates control/bind file descriptor (FD) 330. File descriptor 330 is an inter-process socket with which communication connections can be established as secure communication channels.

Via FD 330, communication connections FD_1 through FD_N are created between root process 310 and user process 320. As illustrated, each of processes 310 and 320 have each of the communication connections defined within them, which allows the processes to communicate over the connections. Having the communication connections may refer to having the protocol and configuration information.

After establishing communication connections FD_1 to FD_N (e.g., FD_1 through FD_10), the control/bind FD 330 is deleted from system 300, preventing other processes from accessing either FD_1 through FD_N, and preventing other processes from establishing other communication connections.

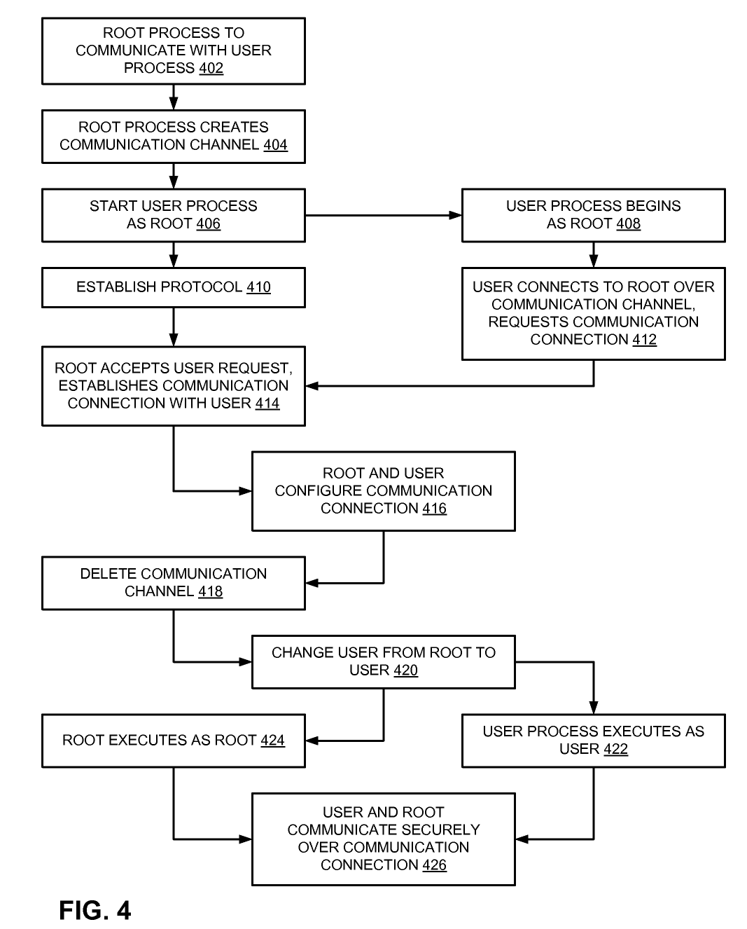

FIG. 4 is a flow diagram of an embodiment of a process for establishing a secure inter-process communication channel. A flow diagram as illustrated herein provides examples of sequences of various process actions. Although shown in a particular sequence or order, unless otherwise specified, the order of the actions can be modified. Thus, the illustrated implementation should be understood only as an example, and the process for establishing the secure channel can be performed in a different order, and some actions may be performed in parallel. Additionally, one or more action can be omitted in various embodiments of the invention; thus, not all actions are required in every implementation. Other process flows are possible.

A root process or a privileged process is to communicate with a user or non-privileged process, 402. The root process creates a communication channel as a control channel, 404. The channel may be an open channel to which the user process connects. In one embodiment, the root process starts the user process as root, 406. The user process can temporarily have its privilege level upgraded during a period of time long enough for the two processes to establish communication connections. Starting the user process as root can prevent security issues during the establishment of the communication connections. The user process begins as root, 408, and the root process establishes a protocol to use for the communication connections, 410.

The user process connects to root over the communication channel, and requests one or more communication connections with the root process, 412. The root process accepts the user request on the open control communication channel, and establishes a communication with the user process, 414. Whereas the communication channel is technically open, and thus available to all processes in the system, the communication connections are available only to the establishing processes.

Jointly, the root process and the user process configure the communication connection, 416. Each process will set up configuration information internally and associate the protocol and the configuration settings with the communication connection. In one embodiment, the blocks 412 through 416 are repeated for multiple communication connections, depending on a configuration of the processes. The root process may then delete the communication channel, preventing further connections from being established, 418. Deleting the communication channel may also effectively “isolate” the communication connections from other access in the system, making them secure.

The root process and/or the user process then change the user process back to user instead of root, 420. The user process then executes normally as user, 422, or a non-privileged user process. Root continues to execute as root, 424, and the user process and the root process communicate securely over the communication connection(s) that are established, 426.

Each component described herein may be a means for performing the functions described. Each components described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc. Software content (e.g., data, instructions, configuration) may be provided via an article of manufacture including a machine readable medium, which provides content that represents instructions that can be executed. The content may result in a machine performing various functions/operations described herein. A machine readable medium includes any mechanism that provides (i.e., stores and/or transmits) information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A machine readable medium may also include a storage or database from which content can be downloaded. A machine readable medium may also include a device or product having content stored thereon at a time of sale or delivery. Thus, delivering a device with stored content, or offering content for download over a communication medium may be understood as providing an article of manufacture with such content described herein.

Besides what is described herein, various modifications may be made to the disclosed embodiments and implementations of the invention without departing from their scope. Therefore, the illustrations and examples herein should be construed in an illustrative, and not a restrictive sense. Additional material attached hereto provides further details and more concepts that are part of this disclosure. The scope of the invention can be identified based on the materials herein, as well as the claims that follow.

What is claimed is:

1. A method for inter-process communication, comprising:
binding a first process of a computing system to a communication channel for communication between the first process and a second process of the computing system;
accepting a connection at the first process by the second process to the communication channel;
establishing a communication connection via the communication channel; and, subsequently,
deleting the communication channel from the computing system without closing the communication connection, to maintain the communication connection active between the first and second processes.

2. The method of claim 1, wherein binding the first process to the communication channel comprises:
opening an inter-procedure call (IPC) socket.

3. The method of claim 2, wherein opening the IPC socket comprises:
opening a Unix domain socket (UDS).

4. The method of claim 1, wherein the first process and the second process have different privilege levels.

5. The method of claim 4, wherein the first process has higher privileges than the second process.

6. The method of claim 5, wherein binding the first process comprises binding a root process to the communication channel, and wherein accepting the connection by the second process comprises accepting the connection by a user process.

7. The method of claim 6, further comprising:
the root process initiating execution of a program as root on the user process that the user process does not have privilege to execute as user.

8. The method of claim 7, further comprising:
the root process changing execution of the program to the user process executing the program as user, after the communication channel has been deleted.

9. The method of claim 1, wherein accepting the connection by the second process comprises:
opening a control connection between the first and second processes, wherein the control connection establishes one or more communication connections between the first and second processes.

10. The method of claim 9, wherein deleting the communication channel without closing the channel comprises:
closing the control connection without closing the communication connections.

11. The method of claim 1, wherein accepting the connection by the second process comprises:
opening a configuration connection to configure the second process to communicate with the first process over the communication connection.

12. The method of claim 11, wherein opening the configuration connection to configure the second process to communicate with the first process comprises:
establishing a communication protocol for the first and second processes to communicate over the communication connection.

13. The method of claim 1, wherein deleting the communication channel comprises:
making the communication channel unavailable to any other process of the computing system.

14. The method of claim 1, wherein deleting the communication channel comprises:
eliminating a transport layer associated with the communication channel to prevent access to the communication channel.

15. An article of manufacture comprising a machine-readable medium having content stored thereon to provide instructions to cause a device to perform operations including:
binding a first process of a computing system to a communication channel for communication between the first process and a second process of the computing system;
accepting a connection at the first process by the second process to the communication channel;
opening a sub-channel via the communication channel, the sub-channel for communication between the first process and the second process;
deleting the communication channel from the computing system; and, subsequently,
communicating from the first process to the second process over the sub-channel after deleting the communication channel from the computing system.

16. The article of manufacture of claim 15, wherein the content for opening the sub-channel comprises content for opening a non-blocking input/output (I/O) channel.

17. The article of manufacture of claim 15, wherein the content for opening the sub-channel further comprises content for opening multiple multiplexing input/output (I/O) channels.

18. A computing system comprising:
a memory to store code representing one or more processes;
a processor to execute the processes and operations provided via the code representing the processes;
a privileged process to be stored in the memory that generates a bind channel, accepts one or more connections via the bind channel to generate communication connections, deletes the bind channel, and communicates over the one or more communication connections; and
a non-privileged process to be stored in the memory that establishes one or more connections with the privileged process via the bind channel, and communicates with the privileged process over the one or more communication connections.

19. The computing system of claim 18, further comprising:
an operating system executing on the processor from the memory that has a filesystem that manages files stored in the computing system as well as inter-process communication sockets, where the bind channel is a socket accessible via the filesystem.

20. The computing system of claim 18, further comprising:
a third process, distinct from the privileged process and the non-privileged process to establish one or more connections with the privileged process via the bind channel, and communicate with the privileged process over the one or more communication connections.
